(19) United States
(12) Patent Application Publication
(10) Pub. No.: US 2024/0361731 A1
(43) Pub. Date: Oct. 31, 2024

(54) METHOD AND INTERNET OF THINGS SYSTEM FOR SAFETY SUPERVISION OF SMART GAS OPERATION QUALITY

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yuefei WU, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 18/764,336

(22) Filed: Jul. 4, 2024

(30) Foreign Application Priority Data
May 23, 2024 (CN) 202410645555.5

(51) Int. Cl. G05B 9/02; G06Q 50/26

(52) U.S. Cl. CPC G05B 9/02; G06Q 50/26

(57) ABSTRACT

The present disclosure provides a method and an Internet of Things system for safety supervision of smart gas operation quality. The method is executed by a government safety supervision management platform, including obtaining initial gas data and first distributed gas data; determining whether the first distributed gas data is abnormal based on the initial gas data; in response to a determination that the first distributed gas data is abnormal, obtaining a residual computing resource, and updating a preset frequency based on the residual computing resource; in response to a determination that a second distributed gas data is abnormal, determining at least one suspect pipeline network segment based on the second distributed gas data; obtaining a first detection data sequence; determining a target regulation parameter based on the first detection data sequence, and generating and transmitting a control instruction to the gas company management platform.

### CROSS-REFERENCE TO RELATED APPLICATIONS

This application claims priority to Chinese Patent Application No. 202410645555.5, filed on May 23, 2024, the entire contents of which are hereby incorporated by reference.

### TECHNICAL FIELD

The present disclosure relates to the field of gas regulation, and in particular relates to methods and Internet of Things (IoT) systems for safety supervision of smart gas operation quality.

### BACKGROUND

In the supervision of urban safety, the supervision of gas supply operation by the relevant government departments is crucial. In the process of gas companies supplying gas to gas users through a gas pipeline network, there may be situations where the gas quality does not meet standards or illegal gas theft occurs. However, the supervision of the gas companies by the relevant government departments is usually carried out manually, which is relatively efficient, and at the same time cannot guarantee the accuracy and timeliness of supervision results.

Therefore, there is a need to provide a method and an Internet of Things (IoT) system for safety supervision of smart gas operation quality, which may intelligently supervise and identify the gas operation quality of the gas company in a full cycle and provide timely targeted warning or adjustment.

### SUMMARY

In order to solve the problem that manual supervision of a gas company is less efficient and cannot ensure the accuracy and timeliness of supervision results, the present disclosure provides a method and an Internet of Things (IoT) system for safety supervision of smart gas operation quality.

Some embodiments of the present disclosure provide a method for safety supervision of smart gas operation quality. The method is executed by a government safety supervision management platform. The method includes obtaining initial gas data uploaded by a gas company management platform through a government safety supervision sensor network platform; obtaining first distributed gas data uploaded by the gas company management platform through the government safety supervision sensor network platform; wherein the first distributed gas data is collected at a preset frequency via a plurality of detection devices deployed at a plurality of preset point locations in a gas pipeline network; determining whether the first distributed gas data is abnormal based on the initial gas data; in response to a determination that the first distributed gas data is abnormal, obtaining a residual computing resource, and updating the preset frequency based on the residual computing resource; obtaining second distributed gas data through the gas company management platform and determining whether the second distributed gas data is abnormal; determining, in response to a determination that the second distributed gas data is abnormal, at least one suspect pipeline network segment, based on the second distributed gas data; obtaining a first detection data sequence of the suspect pipeline network segment uploaded by the gas company management platform through the government safety supervision sensor network platform; and determining a target regulation parameter based on the first detection data sequence, and generating and transmitting a control instruction.

Some embodiments of the present disclosure provide an Internet of Things (IoT) for safety supervision of smart gas operation quality, wherein the IoT system includes a people user platform, a government safety supervision service platform, a government safety supervision management platform, a government safety supervision sensor network platform, a government safety supervision object platform, a gas company management platform, a gas company sensor network platform, a gas equipment object platform, a gas user service platform, and a gas user platform. The government safety supervision management platform is configured to obtain initial gas data uploaded by the gas company management platform through the government safety supervision sensor network platform; obtain first distributed gas data uploaded by the gas company management platform through the government safety supervision sensor network platform, wherein the first distributed gas data is collected at a preset frequency via a plurality of detection devices deployed at a plurality of preset point locations in a gas pipeline network; determine whether the first distributed gas data is abnormal based on the initial gas data; in response to a determination that the first distributed gas data is abnormal, obtain a residual computing resource, and update the preset frequency based on the residual computing resource; obtain second distributed gas data through the gas company management platform and determine whether the second distributed gas data is abnormal; determine, in response to a determination that the second distributed gas data is abnormal, at least one suspect pipeline network segment, based on the second distributed gas data; obtain a first detection data sequence of the suspect pipeline network segment uploaded by the gas company management platform through the government safety supervision sensor network platform; determine a target regulation parameter based on the first detection data sequence, and generate and transmit a control instruction.

The above embodiments include, but are not limited to the following beneficial effects. First, through the initial gas data and distributed gas data, it is possible to quickly and accurately determine gas pipeline network segments that need to be regulated; by determining the target regulation parameter based on the first detection data sequence and generating and sending the control instruction, it is possible to realize comprehensive and intelligent supervision of the gas supply process of the gas company, and by timely issuing a warning and the control instruction to the gas company, uncertainty of manual supervision is reduced and costs of manpower and time are saved. Second, by processing the second detection data and the gas operation characteristic of the target pipeline network segment through the prediction model, it is possible to determine a more accurate abnormal probability of the target pipeline network segment, and then determine a more reasonable target regulation parameter. Third, considering safety hazards that may be caused by the target regulation parameter to the gas company and the gas users when determining the target regulation parameter, a more reasonable target regulation parameter may be determined.

### BRIEF DESCRIPTION OF THE DRAWINGS

The present disclosure is further illustrated in terms of exemplary embodiments. These exemplary embodiments are described in detail with reference to according to the drawings. These embodiments are non-limiting exemplary embodiments, in which like reference numerals represent similar structures, and wherein:

FIG. 1 is a schematic diagram illustrating a platform structure of an Internet of Things (IoT) system for safety supervision of smart gas operation quality according to some embodiments of the present disclosure;

FIG. 2 is an exemplary flowchart illustrating a method for safety supervision of smart gas operation quality according to some embodiments of the present disclosure;

FIG. 3 is an exemplary schematic diagram illustrating determining an abnormal probability for a target pipeline network segment according to some embodiments of the present disclosure;

FIG. 4 is an exemplary flowchart illustrating an exemplary process for determining a target regulation parameter according to some embodiments of the present disclosure; and

FIG. 5 is an exemplary schematic diagram illustrating joint training of a prediction model and an assessment model according to some embodiments of the present disclosure.

### DETAILED DESCRIPTION

To more clearly illustrate the technical solutions related to the embodiments of the present disclosure, a brief introduction of the drawings referred to the description of the embodiments is provided below. The accompanying drawings do not represent the entirety of the embodiments.

It should be understood that the terms “system”, “device”, “unit” and/or “module” as used herein is a way to distinguish different components, elements, parts, sections or assemblies at different levels. However, if other words serve the same purpose, the words may be replaced by other expressions.

Unless the context clearly suggests an exception, the words “one”, “a”, “an”, “a kind”, and/or “the” are not specifically singular, but may also include the plural. Generally, the terms “comprise,” “comprises,” “comprising,” “include,” “includes,” and/or “including,” merely prompt to include operations and elements that have been clearly identified, and these operations and elements do not constitute an exclusive listing. The methods or devices may also include other operations or elements.

When describing the operations performed in the embodiments of the present disclosure in step-by-step instructions, the order of the steps is all interchangeable if not otherwise indicated, the steps may be omitted, and other steps may be included in the process of operation.

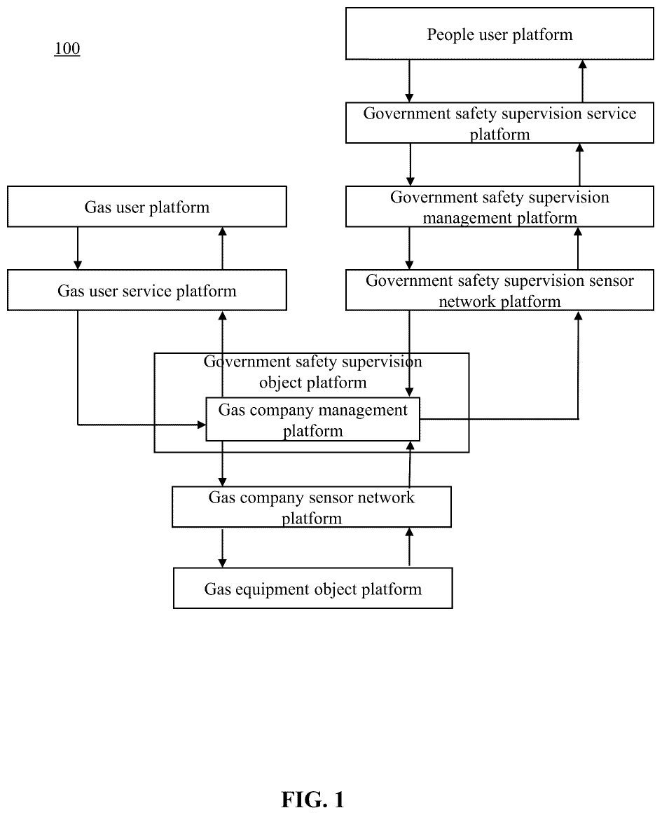

FIG. 1 is a schematic diagram illustrating a platform structure of an Internet of Things (IoT) system for safety supervision of smart gas operation quality according to some embodiments of the present disclosure. As shown in FIG. 1, an IoT system for safety supervision of smart gas operation quality 100 (hereinafter referred to as the IoT system 100) may include a people user platform, a government safety supervision service platform, a government safety supervision management platform, a government safety supervision sensor network platform, a government safety supervision object platform, a gas company management platform, a gas company sensor network platform, a gas equipment object platform, a gas user service platform, and a gas user platform.

The people user platform is a user-driven platform. For example, the people user platform captures needs of users as well as feeds information back to them.

In some embodiments, the people user platform may interact with the government safety supervision service platform.

The government safety supervision service platform is a platform that provides government information and services. In some embodiments, the government safety supervision service platform may interact with the people user platform and the government safety supervision management platform. For example, the government safety supervision service platform may send gas company information to the people user platform. As another example, the government safety supervision service platform may obtain the gas company information from the government safety supervision management platform.

The government safety supervision management platform is a comprehensive management platform for government management information. In some embodiments, the government safety supervision management platform may be configured to process and store data from the IoT system 100.

In some embodiments, the government safety supervision management platform may be configured to obtain initial gas data uploaded by the gas company management platform through the government safety supervision sensor network platform; obtain first distributed gas data uploaded by the gas company management platform through the government safety supervision sensor network platform; determine whether the first distributed gas data is abnormal based on the initial gas data; in response to a determination that the first distributed gas data is abnormal, obtain a residual computing resource, and update a preset frequency based on the residual computing resource; obtain second distributed gas data through the gas company management platform and determine whether the second distributed gas data is abnormal; in response to a determination that the second distributed gas data is abnormal, determine at least one suspect pipeline network segment based on the second distributed gas data; obtain a first detection data sequence of the suspect pipeline network segment uploaded by the gas company management platform through the government safety supervision sensor network platform; and determine a target regulation parameter based on the first detection data sequence, and generate and transmit a control instruction to the gas company management platform.

In some embodiments, the government safety supervision management platform may be further configured to extract, based on the first detection data sequence, a gas operation characteristic of the suspect pipeline network segment; determine a target pipeline network segment and an abnormal probability of the target pipeline network segment based on the gas operation characteristic; and determine the target regulation parameter based on the target pipeline network segment and the abnormal probability of the target pipeline network segment.

In some embodiments, the government safety supervision management platform may be further configured to determine the suspect pipeline network segment where the gas operation characteristic meets a preset requirement as the target pipeline network segment; and obtain second detection data of the target pipeline network segment during a preset time period; and determine the abnormal probability of the target pipeline network segment based on the second detection data and the gas operation characteristic.

In some embodiments, the government safety supervision management platform may be further configured to determine the abnormal probability of the target pipeline network segment, based on the second detection data, the gas operation characteristic of the target pipeline network segment, an abnormality degree of an abnormal point location, weather information, and usage data of a second detection device, through a prediction model.

In some embodiments, the government safety supervision management platform may be further configured to determine a target adjustment object based on location information of the target pipeline network segment; generate at least one candidate regulation parameter; determine a first risk probability and a second risk probability through an assessment model; and determine the target regulation parameter based on the first risk probability and the second risk probability.

In some embodiments, the government safety supervision management platform may be further configured to determine a composite risk by performing a weighted summation on the first risk probability and the second risk probability; and determine the target regulation parameter based on the composite risk.

The government safety supervision sensor network platform is a platform used for comprehensive management of governmental sensing information. In some embodiments, the government safety supervision sensor network platform may interact with the gas company management platform and the government safety supervision management platform. For example, the government safety supervision sensor network platform may obtain the initial gas data uploaded by the gas company management platform. As another example, the government safety supervision sensor network platform may send the initial gas data to the government safety supervision management platform.

The government safety supervision object platform is a platform for supervision information generation and controlling information execution. In some embodiments, the government safety supervision object platform may include the gas company management platform.

The gas company management platform is a comprehensive management platform for the gas company information. In some embodiments, the gas company management platform may interact with the gas user service platform and the government safety supervision sensor network platform. For example, the gas company management platform may obtain user requirements uploaded by the gas user service platform.

The gas company sensor network platform is a platform that comprehensively manages sensing information of a gas company. In some embodiments, the gas company sensor network platform may be configured as a communication network or a gateway, etc.

The gas equipment object platform is a functional platform for sensing information generation and controlling information execution. In some embodiments, the gas equipment object platform may interact with the gas company sensor network platform.

The gas user service platform is a platform that provides gas users with gas services. In some embodiments, the gas user service platform may interact with the gas company management platform and the gas user platform. For example, the gas user service platform may obtain user requirements uploaded by the gas user platform.

The gas user platform is a platform interacting with users. In some embodiments, the gas user platform may be configured as a terminal device. The terminal device may include a mobile device, a tablet computer, a laptop computer, or the like.

In some embodiments, the IoT system 100 may further include a processor. In some embodiments, the processor may process information and/or data related to the IoT system 100 to perform one or more of the functions described in the present disclosure. In some embodiments, the processor may include one or more processing engines (e.g., a single-chip processing engine or a multi-chip processing engine). Merely by way of example, the processor may include a central processing unit (CPU), an application-specific integrated circuit (ASIC), an application-specific instruction processor (ASIP), a graphics processor (GPU), a physical processor (PPU), a digital signal processor (DSP), etc., or any combination of the above. In some embodiments, the processor may interact with a plurality of platforms (e.g., the people user platform, the government safety supervision service platform, and the government safety supervision management platform, or the like) included in the IoT system 100.

In some embodiments, the IoT system 100 may also include a multi-level network. For example, a primary network with a secondary network, etc. For example, the primary network may include a smart gas primary network user platform, a smart gas primary network service platform, a smart gas primary network management platform, a smart gas primary network sensor network platform, and a smart gas primary network object platform. As another example, the secondary network may include a smart gas secondary network user platform, a smart gas secondary network service platform, a smart gas secondary network management platform, a smart gas secondary network sensor network platform, and a smart gas secondary network object platform.

In some embodiments, the platforms in the primary network may interact with the platforms in the secondary network to realize the transmission of information between the primary network and the secondary network. The people user platform, the government safety supervision service platform, the government safety supervision management platform, the government safety supervision sensor network platform, and the government safety supervision object platform in the IoT system 100 constitute the primary network, and the gas user platform, the gas user service platform, the gas company management platform, the gas company sensor network platform, and the gas equipment object platform in the IoT system 100 constitute the secondary network. The gas company management platform is a sub-platform of the government safety supervision object platform. The various platforms in the IoT system 100 may correspond to different functions in different levels of network. For example, the gas company management platform may realize the functions of the object platform in the primary net, and may realize the management functions in the secondary net, or the like.

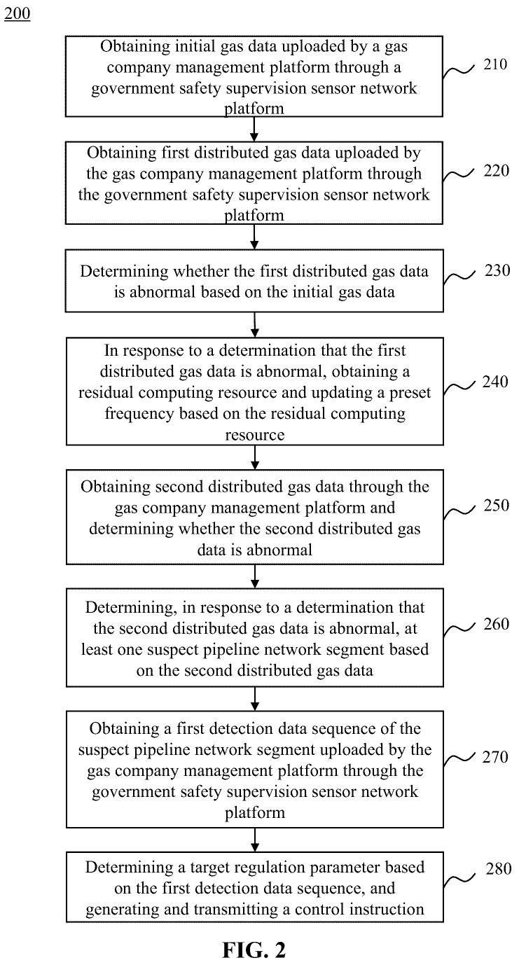

Detailed descriptions regarding the foregoing may be found in FIG. 2 to FIG. 5 and related descriptions thereof.

In some embodiments of the present disclosure, based on the IoT system 100, an information operation closed loop can be formed between various functional platforms, which may coordinate and operate regularly, to realize the informatization and intelligence of the supervision of the smart gas operation quality.

FIG. 2 is an exemplary flowchart illustrating a method for safety supervision of smart gas operation quality according to some embodiments of the present disclosure. In some embodiments, a process 200 is performed by a government safety supervision management platform. As shown in FIG. 2, the process 200 includes the following steps.

In 210, initial gas data uploaded by a gas company management platform is obtained through a government safety supervision sensor network platform.

The initial gas data is data related to gas delivered to a gas pipeline network by a gas company. In some embodiments, the initial gas data may include a composition of the gas and a concentration range thereof.

In some embodiments, the government safety supervision management platform may obtain the initial gas data uploaded by the gas company management platform via the government safety supervision sensor network platform. The gas company management platform may obtain the initial gas data via user input, or the like.

In 220, first distributed gas data uploaded by the gas company management platform is obtained through the government safety supervision sensor network platform.

The first distributed gas data is initially acquired distributed gas data. In some embodiments, the first distributed gas data may be the distributed gas data acquired at an initial preset frequency. The distributed gas data is a composition of gas and its concentration detected at a plurality of preset point locations. More details regarding the preset frequency may be found in the related description hereinafter.

In some embodiments, the first distributed gas data may be collected at the preset frequency via a plurality of detection devices deployed at the plurality of preset point locations in the gas pipeline network and uploaded to the gas company management platform via a gas company sensor network platform.

The preset point locations are preset locations in the gas pipeline network where the detection devices are deployed.

In some embodiments, the preset point locations may include a coupling location where a gas transmission pipeline of the gas company under supervision converges into the gas pipeline network. It may be appreciated that, gas from a plurality of the gas companies may be converged and mixed together into the transmission pipeline after entering the gas pipeline network to be delivered to gas users. The coupling location is a location where the gas delivered by the gas company converges into the gas pipeline. Setting the preset point locations at the coupling location and deploying the detection devices, allows for the collection of the composition of the gas and its concentration range provided by an individual gas company.

In some embodiments, the preset point locations may also include a plurality of locations on the transmission pipeline of the gas pipeline network. The transmission pipeline is configured to transport the gas from the plurality of gas companies. Setting the preset point locations and deploying the detection device at the gas transmission pipeline allows for the collection of the composition of the gas and its concentration range delivered by the plurality of the gas companies after mixing.

The detection devices are devices for collecting the distributed gas data. For example, the detection devices may include a gas concentration detector, a gas composition detector, etc.

The preset frequency is a frequency at which the detection devices collect the distributed gas data. In some embodiments, the preset frequency may be set in advance based on historical experience, for example, collecting the distributed gas data every hour.

In 230, whether the first distributed gas data is abnormal is determined based on the initial gas data.

In some embodiments, the first distributed gas data being abnormal may include a gas composition detected at any one of the plurality of preset point locations being abnormal, and a concentration of the gas composition being abnormal.

The first distributed gas data being abnormal may indicate that one or more of the preset point locations may experience anomalies that include stealing gas, lower gas quality, tampering with gas meters, or the like.

In some embodiments, the government safety supervision management platform may determine reference gas data based on the initial gas data, and determine whether the first distributed gas data is abnormal based on the reference gas data.

The reference gas data is data used to determine whether the distributed gas data is abnormal. In some embodiments, the reference gas data may include a reference gas composition and a reference gas concentration range corresponding to the reference gas composition.

In some embodiments, the government safety supervision management platform may take a concatenated set of gas compositions from initial gas data of the plurality of gas companies, and determine the gas compositions included in the set as the reference gas composition. In some embodiments, the government safety supervision management platform may determine a minimum value and a maximum value of each gas composition in the initial gas data of the plurality of gas companies, determine the minimum value of each gas composition as a lower limit of a reference gas concentration range corresponding to that gas composition, and determine a maximum value of each gas composition as an upper limit of a reference gas concentration range corresponding to that gas composition.

In some embodiments, the government safety supervision management platform may, based on the reference gas data, determine whether there exists in the first distributed gas data a gas composition that is not included in the reference gas composition. In response to a determination that there exists in the first distributed gas data a gas composition that is not included in the reference gas composition, the government safety supervision management platform may determine that the first distributed gas data is abnormal. The gas composition not included in the reference gas composition that exists in the first distributed gas data is a first abnormal composition.

In some embodiments, the government safety supervision management platform may also determine, based on the reference gas data, whether there exists a concentration of any one gas composition in the first distributed gas data that is not in the reference gas concentration range corresponding to the gas composition. In response to a determination that there exists a concentration of any one gas composition is not in the reference gas concentration range corresponding to the gas composition, then the government safety supervision management platform may determine the first distributed gas data is abnormal. When the concentration of the gas composition is not in the reference gas concentration range corresponding to the gas composition, the gas composition is a second abnormal composition. In some embodiments, the situation in which the concentration of the gas composition is not in the reference gas concentration range corresponding to the gas composition may include that the concentration of the gas composition exceeds the upper limit of the reference gas concentration range corresponding to the gas composition by a certain concentration threshold, or the concentration of the gas composition is below the lower limit of the reference gas concentration range corresponding to the gas composition by a certain concentration threshold. The concentration threshold may be preset, e.g., 20 PPM.

In 240, in response to a determination that the first distributed gas data is abnormal, a residual computing resource is obtained, and the preset frequency is updated based on the residual computing resource.

The residual computing resource is a resource that characterizes the IoT system for safety supervision of smart gas operation quality that may be used for system operations (e.g., determining whether second distributed gas data is abnormal and determining a target regulation parameter). For example, the residual computing resource may include free CPU resources, free memory resources, or the like.

In some embodiments, the government safety supervision management platform may automatically obtain the residual computing resource from the various platforms in the IoT system 100.

In some embodiments, the government safety supervision management platform may query a preset frequency table to determine an updated preset frequency based on the residual computing resource. The preset frequency table may include a plurality of residual computing resources and preset frequencies corresponding to the plurality of residual computing resources. In some embodiments, the preset frequency table may be preset based on a correspondence between the residual computing resource and the preset frequency, wherein the correspondence may include that the preset frequency is positively correlated to the residual computing resource, i.e., the more the residual computing resource, the higher the preset frequency.

In 250, the second distributed gas data is obtained through the gas company management platform, and whether the second distributed gas data is abnormal is determined.

The second distributed gas data is the distributed gas data obtained again. In some embodiments, the second distributed gas data may be the distributed gas data obtained at the updated preset frequency. More details regarding the distributed gas data may be found in step 220 and its related description.

In some embodiments, the second distributed gas data may be obtained by collection through the plurality of detection devices deployed at the plurality of preset point locations in the gas pipeline network at the updated preset frequency, and may be uploaded to the gas company management platform through the gas company sensor network platform. In some embodiments, the second distributed gas data may be obtained by collection, after the detection device has operated at the updated preset frequency for a preset length of time, through the detection device at the updated preset frequency, and may be uploaded to the gas company management platform through the gas company sensor network platform. The preset length of time may be set in advance, for example, 1 day.

In some embodiments, the manner of determining whether the second distributed gas data is abnormal is similar to the manner of determining whether the first distributed gas data is abnormal, as described in more detail in the preceding related description.

The second distributed gas data being abnormal may indicate a higher likelihood of abnormal conditions at the preset point locations, requiring adjustments to the gas operations. Descriptions regarding making adjustments to the gas operation may be found in steps 260-280.

In 260, in response to a determination that the second distributed gas data is abnormal, at least one suspect pipeline network segment is determined based on the second distributed gas data.

The suspect pipeline network segment is a gas pipeline network segment in the gas pipeline network that may be abnormal.

In some embodiments, in response to a determination that the second distributed gas data is abnormal, the government safety supervision management platform may determine the gas pipeline network within a preset distance range of an abnormal point location, as the suspect pipeline network segment. The preset distance range may be preset based on historical experience, e.g., 20 m.

In some embodiments, the government safety supervision management platform may determine a preset point location where an abnormal gas composition and/or an abnormal gas concentration occurs in the second distributed gas data and designate the preset point location as the abnormal point location. In some embodiments, the government safety supervision management platform may determine a preset point location where the abnormal gas composition and/or the abnormal gas concentration occurs in the first distributed gas data determine a preset point location where the abnormal gas composition and/or the abnormal gas concentration occurs in the second distributed gas data, and designate preset point locations with simultaneous abnormal occurrence (i.e., both gas data before and after acquisition with abnormal occurrence) as the abnormal point locations.

In 270, a first detection data sequence of the suspect pipeline network segment uploaded by the gas company management platform is obtained through the government safety supervision sensor network platform.

The first detection data sequence refers to a sequence including first detection data. The first detection data refers to data related to the delivery of gas within the suspect pipeline network segment. In some embodiments, the first detection data may include a gas pressure, a gas temperature, a gas flow rate, a gas leakage condition, a reading of a gas metering device, etc., and a plurality of pieces of first detection data in the first detection data sequence may be sequentially arranged in order before and after a collection time point. The gas leakage condition is 0 when there is no gas leakage, and the gas leakage condition may be indicated by a reading of a gas leakage detector when there is gas leakage.

In some embodiments, the first detection data sequence may be obtained by a first detection device deployed in the suspect pipeline network segment during a preset time period, and may be uploaded to the gas company management platform through the gas company sensor network platform. The preset time period refers to a period of time prior to a time point at which an abnormality is judged to occur in the second distributed gas data, for example, 1 day prior to the time point at which an abnormality is judged to occur in the second distributed gas data. In some embodiments, the preset time period may be set in advance.

The first detection device refers to a device that collect the first detection data or the first detection data sequence. In some embodiments, the first detection device may include at least one of a pressure detection device, a temperature detection device, a flow rate detection device, a gas leakage detector, a gas metering device. In some embodiments, the first detection device may be deployed at a plurality of locations in the gas pipeline network, and the plurality of locations may be preset.

In some embodiments, the first detection device may collect a plurality of pieces of first detection data at a plurality of time points within the preset time period to obtain the first detection data sequence. The time points may be preset, e.g., setting a time point every 1 hour.

In 280, a target regulation parameter is determined based on the first detection data sequence, and a control instruction is generated and transmitted.

The target regulation parameter is a parameter used to regulate a gas valve corresponding to the suspect pipeline network segment. The gas valve corresponding to the gas pipeline network segment may be configured to control a gas pressure within the gas pipeline network segment. For example, a gas flow rate may be controlled by varying a size of an opening of the gas valve, which in turn controls the gas pressure within the gas pipeline network segment. In some embodiments, the size of the opening of the gas valve may be controlled by a gas regulator. More details regarding the gas regulator may be found in the related description hereinafter.

In some embodiments, the target regulation parameter may include the gas pressure through the gas valve.

In some embodiments, the government safety supervision management platform may determine the target regulation parameter based on the first detection data sequence in a plurality of ways. For example, in response to a determination that the second distributed gas data is abnormal, the government safety supervision management platform may determine the abnormal point location and an abnormality degree of the abnormal point location, and query the target regulation parameter in a first preset parameter table corresponding to the abnormal point location and the abnormality degree of the abnormal point location based on the abnormality degree of the abnormal point location, and designate the aforementioned target regulation parameter as the target regulation parameter. More details regarding the abnormal point location may be found in step 260 and its related description.

In some embodiments, the first preset parameter table may include a combination of location information of the plurality of abnormal point locations and the abnormality degree, and a target regulation parameter corresponding to the combination. The location information of the abnormal point location may characterize the abnormal point location in the gas pipeline network. The first preset parameter table may be preset based on historical data.

In some embodiments, the government safety supervision management platform may determine the abnormality degree of the abnormal point location based on the first abnormal composition and/or the second abnormal composition corresponding to the abnormal point location. Exemplarily, the government safety supervision management platform may determine the abnormality degree of the abnormal point location based on the following equation (1):

$$Y = a * S + {\sum }_{i = 1}^{i = m} ( {P}_{i} / N ) \qquad ( 1 )$$

Where Y denotes the abnormality degree of the abnormal point location, S denotes a count of the first abnormal compositions corresponding to the abnormal point location, a denotes a coefficient, m denotes a count of the second abnormal compositions corresponding to the abnormal point location, Pi denotes the ith second abnormal composition above or below a reference gas concentration range, and N denotes a concentration threshold. The coefficient may be preset.

In some embodiments, the government safety supervision management platform may extract, based on the first detection data sequence, a gas operation characteristic of the suspect pipeline network segment; determine a target pipeline network segment and an abnormal probability of the target pipeline network segment based on the gas operation characteristic; and determine the target regulation parameter based on the target pipeline network segment and the abnormal probability of the target pipeline network segment.

The gas operation characteristic refers to data that characterize a gas operation condition.

In some embodiments, the gas operation characteristic may include at least one of a composite consistency characteristic or a reading consistency characteristic.

The composite consistency characteristic is data that reflects the consistency of the data (other than the reading of the gas metering device) in the first detection data sequence. Understandably, in the event of abnormalities including stealing gas, lower gas quality, tampering with the gas meter, etc., the data in the first detection data sequence captured at a plurality of time points may be significantly altered, i.e., the composite consistency characteristic may be low.

In some embodiments, the government safety supervision management platform may calculate standard deviations of preset type data in the first detection data sequence and perform a weighted summation of the standard deviations of the preset type data to determine a result of the weighted summation and designate the result as the composite consistency characteristic. The preset type data includes the gas pressure, the gas temperature, the gas flow rate, and the gas leakage. The weights for the weighted summation of standard deviations of different preset types of data may be preset. More details regarding the first detection data sequence may be found in the related description hereinabove.

In some embodiments, the government safety supervision management platform may calculate a standard deviation of the first detection data based on a plurality of pieces of first detection data of the same type collected at a plurality of time points within the preset time period.

The reading consistency characteristic is data that reflects the consistency of an increasing rate of the reading of the gas metering device. It is understandable that in the event of abnormal conditions including stealing gas, low gas quality, tampering with the gas meter, etc., in addition to significant changes in the composite consistency characteristic, the reading of the gas metering device captured at the plurality of time points may also show significant changes, i.e., a lower consistency in the increasing rate.

In some embodiments, the government safety supervision management platform may calculate a standard deviation of the increasing rate of the reading of the gas metering device and determine the standard deviation of the increasing rate as the reading consistency characteristic.

In some embodiments, the government safety supervision management platform may calculate the increasing rate of the gas metering device for every two adjacent time points based on a plurality of readings of the gas metering device captured at the plurality of time points during the preset time period, and calculate a standard deviation of the growth rate based on the plurality of growth rates, and calculate a standard deviation of the increasing rate based on the a plurality of increasing rates. Exemplarily, the government safety supervision management platform may calculate a difference between the readings of the gas metering device at two adjacent time points, and calculate a ratio of the aforementioned difference to a reading of the gas metering device at the previous of the two adjacent time points, and designate the percentage of the ratio as the increasing rate of the reading of the gas metering device at the two adjacent time points.

The target pipeline network segment is a suspect pipeline network segment to be regulated. The target for regulation includes, but is not limited to, one or more of the gas pressure, the gas flow rate, the gas temperature, the gas composition, the gas concentration, or the like.

In some embodiments, the government safety supervision management platform may determine the suspect pipeline network segment whose gas operation characteristic meets a preset requirement as the target pipeline network segment. In some embodiments, the preset requirement may include the composite consistency characteristic exceeding a composite consistency threshold and/or the reading consistency characteristic exceeding a reading consistency threshold. The composite consistency threshold and the read consistency threshold may be preset.

The abnormal probability of the target pipeline network segment is a probability of abnormal occurrence in the target pipeline network segment.

In some embodiments, the government safety supervision management platform may determine the abnormal probability of the target pipeline network segment based on the gas operation characteristic in various ways. For example, the government safety supervision management platform may construct a target characteristic vector based on the gas operation characteristic, match a reference vector that matches the target characteristic vector in a vector database to satisfy a preset matching condition, and count the abnormal probability based on reference abnormal situation corresponding to a reference vector satisfying the preset matching condition. The target characteristic vector may be a characteristic vector constructed based on the composite consistency characteristic and the reading consistency characteristic. In some embodiments, the preset matching condition may include a vector distance being less than a distance threshold, the vector distance may include a Euclidean distance, a cosine distance, etc., and the distance threshold may be preset.

In some embodiments, the government safety supervision management platform may construct the vector database based on the historical data, and the vector database may include a plurality of reference vectors and reference abnormal situations corresponding to the plurality of reference vectors. The reference vectors may be characteristic vectors constructed based on a historical composite consistency characteristic and a historical reading consistency characteristic, and the reference abnormal situations include no abnormal occurrence, stealing gas, lower quality of gas, and tampering with the gas meter.

In some embodiments, the government safety supervision management platform may calculate, based on the reference abnormal situations corresponding to the reference vectors that satisfy the preset matching condition, a ratio of a count of the reference vectors that satisfy the preset matching condition with the reference abnormal situations (other than no abnormal occurrence) to a total count of the reference vectors that satisfy the preset matching condition, and designate the ratio as the abnormal probability.

In some embodiments, the government safety supervision management platform may obtain second detection data of the target pipeline network segment during the preset time period; and determine the abnormal probability of the target pipeline network segment based on the second detection data and the gas operation characteristic.

The second detection data is data related to the surroundings of the target pipeline network segment. In some embodiments, the second detection data may include video data and/or audio data.

In some embodiments, the second detection data may be obtained by collection during the preset time period through a second detection device deployed in the gas pipeline network or the target pipeline network segment, and may be uploaded to the gas company management platform through the gas company sensor network platform.

The second detection device is a device that collects the second detection data. In some embodiments, the second detection device may include a camera device and/or a recording device. In some embodiments, the second detection device may be deployed at a plurality of locations within the gas pipeline network, and the plurality of locations may be preset. It may be appreciated that the second detection device may detect some unusual human activity or sound if the target pipeline network segment is in an abnormal condition.

In some embodiments, the government safety supervision management platform may determine the abnormal probability of the target pipeline network segments based on the second detection data and the gas operation characteristics in various ways. For example, the government safety supervision management platform may determine, based on the second detection data and the gas operation characteristic, by querying the abnormal probability corresponding to the second detection data and the gas operation characteristic in an abnormal probability table, the aforementioned abnormal probability as the abnormal probability of the target pipeline network segment.

In some embodiments, the abnormal probability table may include a combination of a plurality of pieces of second detection data and a plurality of gas operation characteristics, and the abnormal probability corresponding to the combination. The abnormal probability table may be preset based on historical data.

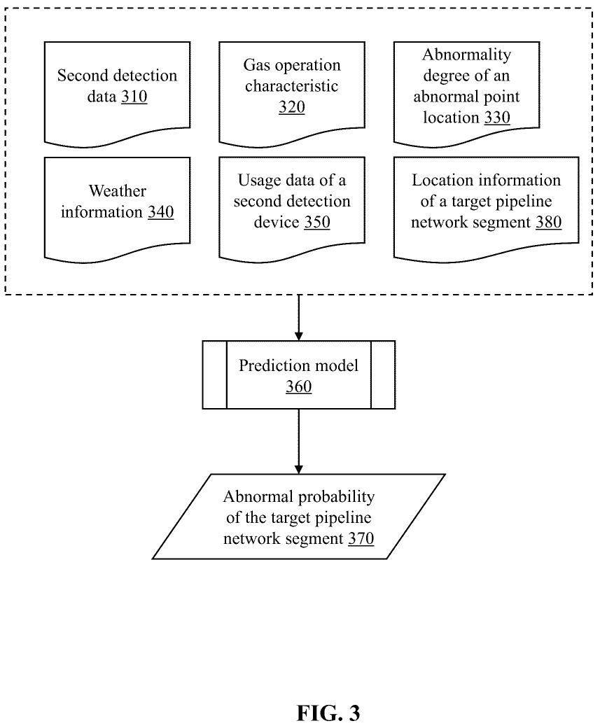

In some embodiments, the government safety supervision management platform may determine the abnormal probability of the target pipeline network segments through a prediction model based on the second detection data and the gas operation characteristic. Further descriptions may be found in FIG. 3.

In some embodiments, the government safety supervision management platform may determine the target regulation parameter based on the target pipeline network segment and the abnormal probability of the target pipeline network segment in a plurality of ways. For example, the government safety supervision management platform may designate, based on the target pipeline network segment and the abnormal probability of the target pipeline network segment, by querying the target regulation parameter corresponding to the target pipeline network segment and the abnormal probability of the target pipeline network segment in a second preset parameter table, use the aforementioned target regulation parameter as the target regulation parameter.

In some embodiments, the second preset parameter table may include a combination of location information and abnormal probabilities of the plurality of target pipeline network segments, and the target regulation parameter corresponding to the combination. The location information of the target pipeline network segments may characterize locations of the target pipeline network segments in the gas pipeline network. The second preset parameter table may be preset based on historical data.

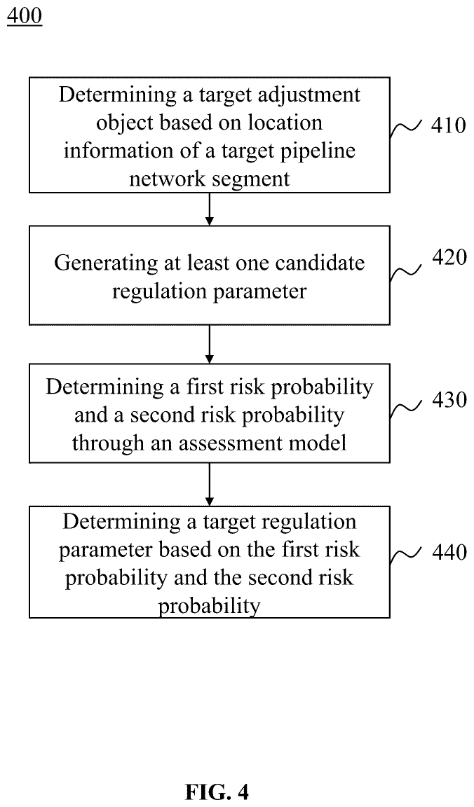

In some embodiments, the government safety supervision management platform may determine a target adjustment object based on the location information of the target pipeline network segment; generate at least one candidate regulation parameter; determine a first risk probability and a second risk probability through an assessment model; and determine the target regulation parameter based on the first risk probability and the second risk probability. Further description may be found in FIG. 4.

In some embodiments of the present disclosure, based on the change in the data in the first detection data sequence, the pipeline network segment to be regulated may be more accurately determined. By taking into account the abnormal probability of the target pipeline network segment when determining the target regulation parameter, a more reasonable target regulation parameter may be obtained.

The control instruction is an instruction used to control the operation of the gas regulator in the gas pipeline network to control the operation of the gas valve according to the target regulation parameter.

In some embodiments, the gas regulator may include a gas regulator, and the gas regulator may control the gas pressure within the gas pipeline network segment by controlling the degree of opening of the gas valve based on the target regulation parameter.

In some embodiments, the government safety supervision management platform may, based on the location information of the abnormal point location, query the gas regulator corresponding to the suspect pipeline network segment in an equipment table, and combine the equipment information of the aforementioned gas regulator with the target regulation parameter to constitute the control instruction. The equipment table may include equipment information of all gas regulators. The equipment information may include a location of the gas regulator, the number of the gas regulator, and the correspondence between the gas regulator and the gas pipeline network segment, etc. The equipment table may be preset.

In some embodiments, the government safety supervision management platform may send the control instruction to the gas company management platform, the gas company management platform sends the control instruction to the gas equipment object platform through the gas company sensor network platform, and the gas equipment object platform controls the gas regulator in the gas pipeline network based on the control instruction, to control the operation of the gas valve according to the target regulation parameter.

In some embodiments of the present disclosure, based on the initial gas data, the first distributed gas data, and the second distributed gas data, the gas pipeline network segment to be regulated may be quickly and accurately determined. The target regulation parameter is determined based on the first detection data sequence, and the control instruction is generated and sent, which realizes comprehensive smart supervision of the gas supply process of the gas company and enables an early warning and the control instruction to be sent the gas company in time, reducing the uncertainty of manual supervision, and save the cost of manpower and time.

It should be noted that the foregoing description of the process 200 is intended to be exemplary and illustrative only and does not limit the scope of application of the present disclosure. For those skilled in the art, various corrections and changes to the process hand-eye calibration may be made under the guidance of the present disclosure. However, these corrections and changes remain within the scope of the present disclosure.

FIG. 3 is an exemplary schematic diagram illustrating determining an abnormal probability for a target pipeline network segment according to some embodiments of the present disclosure.

In some embodiments, as shown in FIG. 3, a government safety supervision management platform may determine, based on second detection data 310, a gas operation characteristic 320 of a target pipeline network segment, an abnormality degree 330 of an abnormal point location, weather information 340, and usage data 350 of a second detection device, an abnormal probability 370 of the target pipeline network segment through a prediction model 360.

The prediction model refers to a model for determining the abnormal probability for the target pipeline network segment. In some embodiments, the prediction model may be a machine learning model. For example, the prediction model may include any one or a combination of a deep neural network (CNN) model, a support vector machine (SVM) model, or other customized model structures.

In some embodiments, as shown in FIG. 3, an input of the prediction model 360 may include the second detection data 310, the gas operation characteristic 320 of the individual target pipeline network segment, the abnormality degree 330 of the abnormal point location, the weather information 340, and the usage data 350 of the second detection device, and an output of the prediction model 360 may include the abnormal probability 370 of the individual target pipeline network segment. The abnormality degree 330 of the abnormal point location inputted to the prediction model 360 may include abnormality degrees of all the abnormal point locations. More details regarding the second detection data, the gas operation characteristic of the target pipeline network segment, and the abnormality degree of the abnormal point location may be found in FIG. 2 and related descriptions thereof.

The weather information refers to weather conditions when a first detection device and the second detection device collect data. For example, there is a weather condition such as rainfall or wind. In some embodiments, the government safety supervision management platform may obtain the weather information through a third-party platform. It will be appreciated that the weather condition may affect the accuracy of the data collected by the first detection device and the second detection device. Therefore, when determining the abnormal probability of the target pipeline network segment using the prediction model, considering the weather condition may result in a more accurate abnormal probability.

The usage data of the second detection device is data related to the operation of the second detection device at historical times. In some embodiments, the usage data of the second detection device may include the age of the second detection device, maintenance of the second detection device, or the like. In some embodiments, the government safety supervision management platform may obtain the usage data of the second detection device through the gas company management platform.

In some embodiments, the input of the prediction model 360 may also include location information 380 of the target pipeline network segment, as shown in FIG. 3. More details regarding the location information for the target pipeline network segment may be found in step 280 and related descriptions thereof.

In some embodiments, the government safety supervision management platform may determine the abnormal probabilities of a plurality of target pipeline network segments simultaneously through the prediction model. In this embodiment, the input of the prediction model may include the second detection data, the gas operation characteristics of the plurality of target pipeline network segments, the abnormality degree of the abnormal point location, the weather information, the usage data of the second detection device, and the location information of the plurality of target pipeline network segments. In some embodiments, the location information of the plurality of target pipeline network segments may be represented by a graph structure.

In some embodiments, the government safety supervision management platform may construct the graph structure based on the location information of the plurality of target pipeline network segments. Nodes of the graph structure represent the target pipeline network segment. Node characteristics may include the location information of the target pipeline network segment and maintenance data of the target pipeline network segment. The maintenance data may include a count of maintenance of the target pipeline network segment, a maintenance time, or the like. In some embodiments, the government safety supervision management platform may obtain the maintenance data of the target pipeline network segments through the gas company management platform.

Edges of the graph structure may characterize connectivity between nodes. In some embodiments, the edges of the graph structure may include connectivity between any of the target pipeline network segments. Edge characteristics may include a distance between target pipeline network segments and transportation accessibility between the target pipeline network segments. The transportation accessibility may characterize a degree of remoteness of the geographic location where a target pipeline network segment is located. The lower the transportation accessibility, the more remote the geographic location of the target pipeline network segment is, and the more likely it is to be abnormal.

In some embodiments, when the location information of the plurality of the target pipeline network segments input to the prediction model is represented in the graph structure, the prediction model may be a graph neural network (GNN) model. The node in the GNN outputs the abnormal probability corresponding to the target pipeline network segment. In some embodiments, the prediction model may also be another graph model, such as a graph convolutional neural network (GCNN) model, or other processing layers may be added to the graph neural network model, modifications made to its processing, or the like.

In some embodiments of the present disclosure, adding the location information of the target pipeline network segment to the input of the prediction model may take into account the influence between the plurality of the target pipeline network segments and the degree of remoteness of the target pipeline network segment in determining the abnormal probability, to obtain a more accurate abnormal probability, while using GNN may better capture the topology and relationship information in the graph structure to improve the accuracy of prediction.

In some embodiments, the government safety supervision management platform may train the prediction model based on a plurality of first training samples with a first label by a gradient descent algorithm, or the like. The first training samples may include a sample gas operation characteristic of a sample target pipeline network segment, sample second detection data, a sample abnormality degree of a sample abnormal point location, sample weather information, sample usage data of a sample second detection device, and the first label of the first training sample may include whether the sample target pipeline network segment is abnormal and an abnormal type. The abnormal type may include theft of gas, lower quality of gas, tampering with a gas meter, or the like.

In some embodiments, the first training sample may be obtained based on historical data. In some embodiments, the first label may be determined based on manual labeling, for example, by the number 1 or 0 to indicate the occurrence of an anomaly or the absence of an anomaly. Exemplarily, if the first training sample corresponds to a historical time period in which the anomaly actually occurs, the first training sample corresponds to a first label of (1, abnormal type).

In some embodiments, the time period in which each of the training samples (i.e., the first training samples) in a training set for training the prediction model is located are normally distributed. The training set for training the prediction model may include the plurality of first training samples with the first label. The time period in which the first training samples are located refers to the time period in which the first training samples are obtained.

The time period in which the first training samples are normally distributed refers to a count of the first training samples constructed at each time period being normally distributed. In some embodiments, a mean of the normal distribution is in a preset night time period, i.e., the first training samples are obtained centrally in the preset night time period.

The preset night time period is a period at night. Understandably, the time period where the anomaly occurs is usually in the night time, so a more realistic and effective first training sample may be obtained in a night time period. In some embodiments, the count of the first training samples obtained at different time periods of the preset night time period may also be different, and the greater the probability of abnormal occurrence at the preset night time period close to the sunrise time period, the greater the count of the first training samples obtained at that time period.

In some embodiments of the present disclosure, since the time period in which the abnormal situation occurs is usually in the nighttime, by obtaining the plurality of first training samples in the preset night time period, a plurality of the training samples close to the actual situation and more effective may be added to the training of the prediction model to obtain a more accurate abnormal probability.

In some embodiments of the present disclosure, by utilizing the self-learning capability of the machine learning model, a pattern may be found from a large amount of data. At the same time, when determining the abnormal probability, taking into account the influence of the weather factor and factors of the device on the accuracy of the data, may determine a more accurate abnormal probability.

FIG. 4 is an exemplary flowchart illustrating an exemplary process for determining a target regulation parameter according to some embodiments of the present disclosure.

In 410, a target adjustment object is determined based on location information of a target pipeline network segment.

The target adjustment object is a gas company that supplies gas to the target pipeline network segment. The target adjustment object may be one or more.

In some embodiments, a government safety supervision management platform may determine an upstream pipeline of the target pipeline network segment based on the location information of the target pipeline network segment, and determine the gas company that supplies gas to the target pipeline network segment through the upstream pipeline as the target adjustment object.

In 420, at least one candidate regulation parameter is generated.

The candidate regulation parameter is a regulation parameter that is candidate.

In some embodiments, the government safety supervision management platform may determine a preset value of the target regulation parameter and randomly generate a certain count of the candidate regulation parameters within a preset range of the preset value of the target regulation parameter. The preset range may be set in advance. For example, a lower limit of the preset range is 90% of the target regulation parameter, and an upper limit of the preset range is 110% of the target regulation parameter. In some embodiments, the government safety supervision management platform may determine a preset value of the target regulation parameter by querying a second preset parameter table. More details regarding the second preset parameter table may be found in step 280 and related descriptions thereof.

In 430, a first risk probability and a second risk probability are determined through an assessment model.

In some embodiments, the first risk probability may represent a probability that the target adjustment object has a detection risk under the candidate regulation parameter. Each candidate regulation parameter may correspond to determining a first risk probability.

In some embodiments, the detection risk may include the risk of a safety accident occurring during the detection of the target pipeline network segment. The safety accident occurring during the detection may include gas explosions due to substandard gas quality, excessive gas pressure, etc.

In some embodiments, the second risk probability may represent a probability that a gas user corresponding to the target pipeline network segment has a gas usage risk under the candidate regulation parameter. The gas user corresponding to the target pipeline network segment is the gas user that uses gas delivered by the target pipeline network segment. Each candidate regulation parameter may correspond to determining a second risk probability.

In some embodiments, the gas usage risk may include the risk of the safety accident while using the gas. The safety accident while using gas may include gas leakage, gas explosion, or the like.

In some embodiments, the government safety supervision management platform may determine the first risk probability and the second risk probability through the assessment model. More details regarding the assessment model may be found in the related description hereinafter.

In 440, the target regulation parameter is determined based on the first risk probability and the second risk probability.

In some embodiments, the government safety supervision management platform may determine the target regulation parameter based on the first risk probability and the second risk probability in a plurality of ways. For example, the government safety supervision management platform may select, from the plurality of candidate regulation parameters, the candidate regulation parameter with a minimum sum of the first risk probability and the second risk probability and determine the candidate regulation parameter as the target regulation parameter.

In some embodiments, the government safety supervision management platform may perform a weighted summation on the first risk probability and the second risk probability to determine a composite risk, and determine the target regulation parameter based on the composite risk. The weight of the second risk probability may be positively correlated to a count of the gas users corresponding to the target pipeline network segments, and the greater the count of the gas users, the greater the weight of the second risk probability.

The composite risk is a probability of the safety accident for the target adjustment object and the gas user under the candidate regulation parameter. Each candidate regulation parameter corresponds to determining a composite risk.

In some embodiments, the government safety supervision management platform may determine a candidate regulation parameter with a minimum composite risk as the target regulation parameter.

In some embodiments of the present disclosure, by analyzing the first risk probability and the second risk probability, and by considering the count of the gas users that may experience the safety accident, the target regulation parameter with higher safety may be obtained.

In some embodiments of the present disclosure, by determining the candidate regulation parameter and evaluating the first risk probability and the second risk probability of the candidate regulation parameter, the target regulation parameter is determined, which improves the safety.

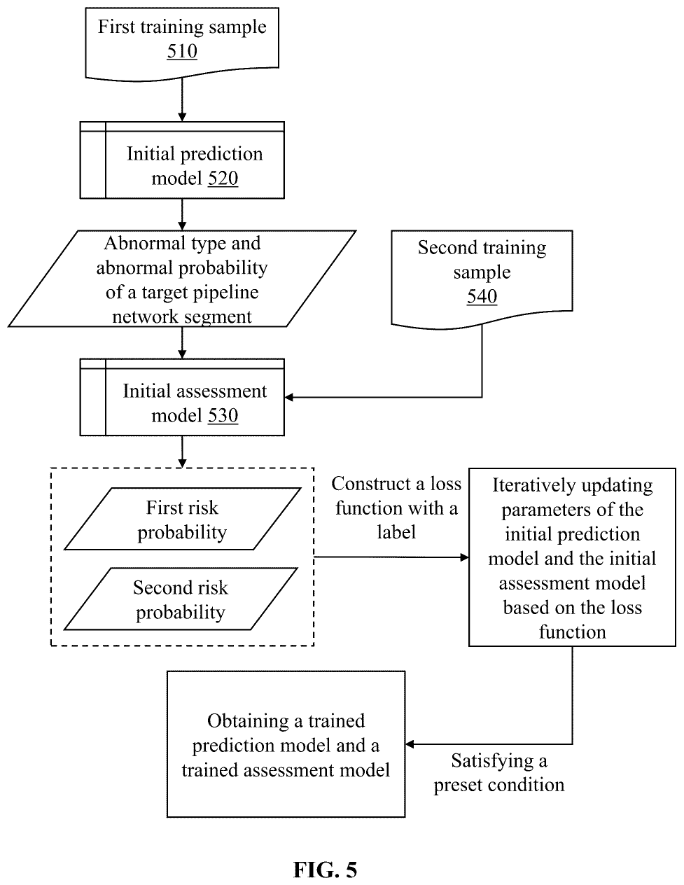

FIG. 5 is an exemplary schematic diagram illustrating joint training of a prediction model and an assessment model according to some embodiments of the present disclosure.

The assessment model refers to a model for determining a first risk probability and a second risk probability. In some embodiments, the assessment model may be a machine learning model. For example, the assessment model may include any one or a combination of a deep neural network (CNN) model, a support vector machine (SVM) model, or other customized model structures, etc.

In some embodiments, an input of the assessment model may include an abnormal type of a target pipeline network segment and an abnormal probability of the target pipeline network segment, a candidate regulation parameter, related data of the target adjustment object, a type and a count of gas users corresponding to the target pipeline network segment, and an output of the assessment model may include the first risk probability and the second risk probability. More details regarding the abnormal type of the target pipeline network segment, the abnormal probability of the target pipeline network segment, and the candidate regulation parameter may be found elsewhere in the present disclosure (e.g., FIG. 2, FIG. 3, and the relevant descriptions).

The related data of the target adjustment object may include a size of the target adjustment object, a count of historical safety accidents, a count of historical user complaints, or the like. In some embodiments, a government safety supervision management platform may obtain the related data of the target adjustment object through a gas company management platform.

The type of the gas users corresponding to the target pipeline network segment may include a commercial gas user and a residential gas user. More details regarding the gas users corresponding to the target pipeline network segment may be found in step 430 and associated descriptions thereof.

In some embodiments, the government safety supervision management platform may obtain the type and the count of the gas users corresponding to the target pipeline network segment through the gas company management platform.

In some embodiments of the present disclosure, by processing the abnormal type of the target pipeline network segment and the abnormal probability of the target pipeline network segment, the candidate regulation parameter, the related data of the target adjustment object, and the type and the count of the gas users corresponding to the target pipeline network segment through the assessment model, the unique advantage of the machine learning model may be utilized to clarify a correlation relationship between the input and the output based on a plurality of pieces of complex data to obtain a more accurate first risk probability and second risk probability.

In some embodiments, an output of the prediction model may be used as an input of the assessment model. In some embodiments, the assessment model and the prediction model may be obtained by the joint training based on a plurality of training samples with labels. In some embodiments, the training samples may include a first training sample 510 and a second training sample 540. The first training sample 510 may include a sample gas operation characteristic of a sample target pipeline network segment, sample second detection data, an abnormality degree of a sample abnormal point location, sample weather information, and sample usage data of a sample second detection device. The second training sample 540 may include a sample candidate regulation parameter, sample related data of the target adjustment object, and a type and a count of gas users corresponding to the sample target pipeline network segment. The labels may be the first risk probability and the second risk probability corresponding to the sample target pipeline network segment. The second training sample 540 may be obtained based on historical data. More details regarding the first training sample may be found in FIG. 3 and related descriptions thereof.

In some embodiments, the process of the joint training includes inputting the first training sample into an initial prediction model 520, inputting an output of the initial prediction model 520 (the abnormal type and the abnormal probability of the sample target pipeline network segment) and the second training sample 540 into an initial assessment model 530, constructing a loss function based on an output of the initial assessment model 530 (the first risk probability and the second risk probability) and the labels, and iteratively updating parameters of the initial prediction model 520 and the initial assessment model 530 based on the loss function until a preset iteration condition is satisfied to obtain a trained prediction model and a trained assessment model, wherein the preset iteration condition includes the loss function being less than a threshold value, converging, or the training period reaching a threshold value.

In some embodiments of the present disclosure, by the joint training of the prediction model and the assessment model, it is beneficial to reduce the difficulty of training the assessment model separately, and to improve the accuracy of the prediction model and the assessment model obtained by the training.

In some embodiments, the government safety supervision management platform may train the assessment model based on a plurality of third training samples with labels by a gradient descent algorithm, etc. The third training samples may include the abnormal type and the abnormal probability of the sample target pipeline network segment, the sample candidate regulation parameter, the sample related data of the target adjustment object, the type and the count of the gas users corresponding to the sample target pipeline network segment. Labels of the third training samples may include a first sub-label and a second sub-label, the first sub-label corresponding to the first risk probability, and the second sub-label corresponding to the second risk probability.

In some embodiments, the third training sample may be obtained based on historical data. In some embodiments, the first sub-label and the second sub-label may be determined based on manual labeling, e.g., by a number 1 or 0 indicating the occurrence of a safety accident or the absence of a safety accident. Exemplarily, if the target adjustment object corresponding to the sample target pipeline network segment has a safety accident when the sample target pipeline network segment is inspected during a historical time period corresponding to the second training sample, the first sub-label is 1, and otherwise is 0. Exemplarily, if the gas users corresponding to the sample target pipeline network segment has the safety accident while using gas in the historical time period corresponding to the second training sample, the second sub-label is 1 and otherwise is 0.

Some embodiments of the present disclosure further provide a non-transitory computer-readable storage medium storing computer instructions. When a computer reads the computer instructions in the storage medium, the computer executes the method for safety supervision of smart gas operation quality as described in any of the above embodiments.

In addition, some features, structures, or characteristics of one or more embodiments of the present disclosure may be suitably combined.

In some embodiments, the numbers expressing quantities or properties used to describe and claim certain embodiments of the present disclosure are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

In the event of any inconsistency or conflict between the descriptions, definitions, and/or use of terminology in the materials cited in the present disclosure and those described in the present disclosure, the descriptions, definitions, and/or use of terminology in the present disclosure shall prevail.

What is claimed is:

1. A method for safety supervision of smart gas operation quality, wherein the method is executed by a government safety supervision management platform of an Internet of things system for safety supervision of smart gas operation quality, and the method comprises:
obtaining initial gas data uploaded by a gas company management platform through a government safety supervision sensor network platform;
obtaining first distributed gas data uploaded by the gas company management platform through the government safety supervision sensor network platform, wherein the first distributed gas data is collected at a preset frequency via a plurality of detection devices deployed at a plurality of preset point locations in a gas pipeline network, and the preset point locations include a coupling location where a gas transmission pipeline of a gas company under supervision converges into the gas pipeline network;
determining whether the first distributed gas data is abnormal based on the initial gas data;
in response to a determination that the first distributed gas data is abnormal, obtaining a residual computing resource, and updating the preset frequency based on the residual computing resource, wherein the residual computing resource is a resource capable of being used for computing;
obtaining second distributed gas data through the gas company management platform and determining whether the second distributed gas data is abnormal, wherein the second distributed gas data is collected at an updated preset frequency via the plurality of detection devices deployed at the plurality of preset point locations in the gas pipeline network;
determining, in response to a determination that the second distributed gas data is abnormal, at least one suspect pipeline network segment based on the second distributed gas data, wherein the suspect pipeline network segment is a gas pipeline network segment with a probability of abnormal occurrence in the gas pipeline network;
obtaining a first detection data sequence of the suspect pipeline network segment uploaded by the gas company management platform through the government safety supervision sensor network platform, wherein the first detection data sequence is collected during a preset time period via a first detection device deployed in the suspect pipeline network segment, and the first detection device includes at least one of a pressure detection device, a temperature detection device, a flow rate detection device, a gas leakage detector, and a gas metering device; and
determining a target regulation parameter based on the first detection data sequence, and generating and transmitting a control instruction, wherein the control instruction is used to control at least one gas regulator in the gas pipeline network to control at least one gas valve according to the target regulation parameter; the target regulation parameter including a gas pressure through the at least one gas valve.

2. The method of claim 1, wherein the determining a target regulation parameter based on the first detection data sequence includes:
extracting, based on the first detection data sequence, a gas operation characteristic of the suspect pipeline network segment, wherein the gas operation characteristic includes at least one of a composite consistency characteristic and a reading consistency characteristic;
determining a target pipeline network segment and an abnormal probability of the target pipeline network segment based on the gas operation characteristic; and
determining the target regulation parameter based on the target pipeline network segment and the abnormal probability of the target pipeline network segment.

3. The method of claim 2, wherein the determining a target pipeline network segment and an abnormal probability of the target pipeline network segment based on the gas operation characteristic, includes:
determining the suspect pipeline network segment where the gas operation characteristic meets a preset requirement as the target pipeline network segment;
obtaining second detection data of the target pipeline network segment during the preset time period, wherein the second detection data is obtained by collection during the preset time period via a second detection device deployed in the target pipeline network segment, and the second detection device includes a camera device and/or a recording device; and
determining the abnormal probability of the target pipeline network segment based on the second detection data and the gas operation characteristic.

4. The method of claim 3, wherein the determining the abnormal probability of the target pipeline network segment based on the second detection data and the gas operation characteristic, includes:
determining the abnormal probability of the target pipeline network segment based on the second detection data, the gas operation characteristic of the target pipeline network segment, an abnormality degree of an abnormal point location, weather information, and usage data of the second detection device through a prediction model, wherein the prediction model is a machine learning model.

5. The method of claim 4, wherein an input of the prediction model further includes location information of the target pipeline network segment, the location information of the target pipeline network segment is represented by a graph structure, and the prediction model includes a graph neural network model.

6. The method of claim 4, wherein in a training set for training the prediction model, time periods during which each training sample is located are in a normal distribution, wherein a mean of the normal distribution is at a preset night time period.

7. The method of claim 2, wherein the determining the target regulation parameter based on the target pipeline network segment and the abnormal probability of the target pipeline network segment includes:
determining a target adjustment object based on location information of the target pipeline network segment;
generating at least one candidate regulation parameter;
determining a first risk probability and a second risk probability through an assessment model, wherein:
the first risk probability indicates a probability of a detection risk of the target adjustment object under the candidate regulation parameter,
the detection risk includes a risk of a safety accident occurring during detection of the target pipeline network segment,
the second risk probability indicates a probability of a gas usage risk of gas users corresponding to the target pipeline network segment under the candidate regulation parameter, and
the gas usage risk includes a risk of a safety accident occurring when using gas, and the assessment model is a machine learning model; and
determining the target regulation parameter based on the first risk probability and the second risk probability.

8. The method of claim 7, wherein an input of the assessment model includes an abnormal type and the abnormal probability of the target pipeline network segment, the candidate regulation parameter, related data of the target adjustment object, a type and a count of the gas users corresponding to the target pipeline network segment, and an output of the assessment model includes the first risk probability and the second risk probability.

9. The method of claim 7, wherein the assessment model and a prediction model are obtained by joint training based on a plurality of training samples with a label, the plurality of training samples includes a first training sample and a second training sample, the first training sample includes a sample gas operation characteristic of a sample target pipeline network segment, sample second detection data, a sample abnormality degree of a sample abnormal point location, sample weather information, and a sample usage data of a sample second detection device, the second training sample includes a sample candidate regulation parameter, related data of a sample target adjustment object, and a type and a count of gas users corresponding to the sample target pipeline network segment, and the label includes the first risk probability and the second risk probability corresponding to the sample target pipeline network segment; and
a process of the joint training includes:
inputting the first training sample with the label into an initial prediction model,
inputting an output of the initial prediction model and the second training sample into an initial assessment model,
constructing a loss function based on an output of the initial assessment model and the label, iteratively updating parameters of the initial prediction model and the initial assessment model based on the loss function until a preset condition is satisfied, and obtaining a trained prediction model and a trained assessment model, wherein the preset condition includes the loss function being less than a threshold, converging, or a iteration period reaching a threshold.

10. The method of claim 7, wherein the determining the target regulation parameter based on the first risk probability and the second risk probability includes:
determining a composite risk by performing a weighted summation on the first risk probability and the second risk probability, wherein a weight of the second risk probability is positively correlated to a count of the gas users corresponding to the target pipeline network segment; and
determine the target regulation parameter based on the composite risk.

11. An Internet of Things (IoT) system safety supervision of smart gas operation quality, wherein the IoT system includes a people user platform, a government safety supervision service platform, a government safety supervision management platform, a government safety supervision sensor network platform, a government safety supervision object platform, a gas company management platform, a gas company sensor network platform, a gas equipment object platform, a gas user service platform, and a gas user platform, and the government safety supervision management platform is configured to:
obtain initial gas data uploaded by the gas company management platform through the government safety supervision sensor network platform;
obtain first distributed gas data uploaded by the gas company management platform through the government safety supervision sensor network platform, wherein the first distributed gas data is collected at a preset frequency via a plurality of detection devices deployed at a plurality of preset point locations in a gas pipeline network, and the preset point locations include a coupling location where a gas transmission pipeline of a gas company under supervision converges into the gas pipeline network;
determine whether the first distributed gas data is abnormal based on the initial gas data;
in response to a determination that the first distributed gas data is abnormal, obtain a residual computing resource and update the preset frequency based on the residual computing resource, wherein the residual computing resource is a resource capable of being used for computing;
obtain second distributed gas data through the gas company management platform and determine whether the second distributed gas data is abnormal, wherein the second distributed gas data is collected at an updated preset frequency via the plurality of detection devices deployed at the plurality of preset point locations in the gas pipeline network;
determine, in response to a determination that the second distributed gas data is abnormal, at least one suspect pipeline network segment based on the second distributed gas data, wherein the suspect pipeline network segment is a gas pipeline network segment with a probability of abnormal occurrence in the gas pipeline network;
obtain a first detection data sequence of the suspect pipeline network segment uploaded by the gas company management platform through the government safety supervision sensor network platform, wherein the first detection data sequence is collected during a preset time period via a first detection device deployed in the suspect pipeline network segment, and the first detection device includes at least one of a pressure detection device, a temperature detection device, a flow rate detection device, a gas leakage detector, and a gas metering device; and
determine a target regulation parameter based on the first detection data sequence, and generate and transmit a control instruction, wherein the control instruction is used to control at least one gas regulator in the gas pipeline network to control at least one gas valve according to the target regulation parameter operation; the target regulation parameter including a gas pressure when passing through the at least one gas valve.

12. The IoT system of claim 11, wherein the government safety supervision management platform is further configured to:
extract, based on the first detection data sequence, a gas operation characteristic of the suspect pipeline network segment, wherein the gas operation characteristic includes at least one of a composite consistency characteristic, and a reading consistency characteristic;
determine a target pipeline network segment and an abnormal probability of the target pipeline network segment based on the gas operation characteristic; and
determine the target regulation parameter based on the target pipeline network segment and the abnormal probability of the target pipeline network segment.

13. The IoT system of claim 12, wherein the government safety supervision management platform is further configured to:
determine the suspect pipeline network segment where the gas operation characteristic meets a preset requirement as the target pipeline network segment;
obtain second detection data of the target pipeline network segment during the preset time period, wherein the second detection data is obtained by collection during the preset time period via a second detection device deployed in the target pipeline network segment, and the second detection device includes a camera device and/or a recording device; and
determine the abnormal probability of the target pipeline network segment based on the second detection data and the gas operation characteristic.

14. The IoT system of claim 13, wherein the government safety supervision management platform is further configured to:
determine the abnormal probability of the target pipeline network segment based on the second detection data, the gas operation characteristic of the target pipeline network segment, an abnormality degree of an abnormal point location, weather information, and usage data of the second detection device through a prediction model, wherein the prediction model is a machine learning model.

15. The IoT system of claim 14, wherein an input of the prediction model further includes location information of the target pipeline network segment, the location information of the target pipeline network segment is represented by a graph structure, and the prediction model includes a graph neural network model.

16. The IoT system of claim 11, wherein the government safety supervision management platform is further configured to:
determine a target adjustment object based on the location information of the target pipeline network segment;
generate at least one candidate regulation parameter;
determine a first risk probability and a second risk probability through an assessment model, wherein:
the first risk probability indicates a probability of a detection risk of the target adjustment object under the candidate regulation parameter,
the detection risk includes a risk of a safety accident occurring during detection of the target pipeline network segment,
the second risk probability indicates a probability of a gas usage risk of gas users corresponding to the target pipeline network segment under the candidate regulation parameter, and
the gas usage risk includes a risk of a safety accident occurring when using gas, and the assessment model is a machine learning model; and
determine the target regulation parameter based on the first risk probability and the second risk probability.

17. The IoT system of claim 16, wherein an input of the assessment model includes an abnormal type and the abnormal probability of the target pipeline network segment, the candidate regulation parameter, related data of the target adjustment object, and a type and a count of the gas users corresponding to the target pipeline network segment, and an output of the assessment model includes the first risk probability and the second risk probability.

18. The IoT system of claim 16, wherein the assessment model and a prediction model are obtained by joint training based on a plurality of training samples with a label, the plurality of training samples include a first training sample and a second training sample, the first training sample includes a sample gas operation characteristic of a sample target pipeline network segment, sample second detection data, a sample abnormality degree of a sample abnormal point location, sample weather information, and sample usage data of a sample second detection device, the second training sample includes a sample candidate regulation parameter, related data of a sample target adjustment object, and a type and a count of the gas users corresponding to the sample target pipeline network segment, and the label includes the first risk probability and the second risk probability corresponding to the sample target pipeline network segment; and
a process of the joint training includes:
inputting the first training sample with the label into an initial prediction model,
inputting an output of the initial prediction model and the second training sample into an initial assessment model,
constructing a loss function based on an output of the initial assessment model and the label, iteratively updating parameters of the initial prediction model and the initial assessment model based on the loss function until a preset condition is satisfied, and obtaining a trained prediction model and a trained assessment model, wherein the preset condition includes the loss function being less than a threshold, converging, or an iteration period reaching a threshold.

19. The IoT system of claim 16, wherein the government safety supervision management platform is further configured to:
determine a composite risk by performing a weighted summation on the first risk probability and the second risk probability, wherein a weight of the second risk probability is positively correlated to a count of the gas users corresponding to the target pipeline network segment; and
determine the target regulation parameter based on the composite risk.

20. A non-transitory computer-readable storage medium storing computer instructions, wherein when a computer reads the computer instructions in the storage medium, the computer performs the method of claim 1.
